(19) United States
(12) Patent Application Publication
(10) Pub. No.: US 2018/0304754 A1
(43) Pub. Date: Oct. 25, 2018

(54) ELECTROMAGNETIC PISTON ENGINE

(71) Applicant: Nav Kandola, Vancouver (CA)

(72) Inventor: Nav Kandola, Vancouver (CA)

(21) Appl. No.: 15/491,559

(22) Filed: Apr. 19, 2017

(51) Int. Cl. B60L 11/18; H02K 1/34; H02K 7/14; H02K 53/00; H02K 7/18

(52) U.S. Cl. CPC B60L 11/18; H02K 1/34; H02K 7/1815; H02K 53/00; H02K 7/14

(57) ABSTRACT

An electromagnetic piston engine is characterized by an engine block containing at least one cylinder, within which at least one electromagnet is positions. Within the cylinder, the present invention may also provide for a piston attached to a camshaft, the piston having a magnetic end element fixably attached to its terminus. By means of a power source, the present invention may energize the electromagnet(s), which may provide for an electromagnetic force to be generated within the cylinder and which may act on the magnetic end element(s). The effect of this electromagnetic force may be to either attract or repel, or alternatingly attract and repel, the magnetic end element, thereby moving the piston back and forth within the cylinder, rotating the camshaft and powering a vehicle.

### CROSS-REFERENCE TO RELATED APPLICATION

Not applicable.

### TECHNICAL FIELD

The disclosed subject matter relates generally to piston heads and, more particularly, to an electromagnetic piston engine.

### BACKGROUND

Many people would agree that humankind must reduce its dependency on fossil fuels for powering the vehicles we drive. This dependency on fossil fuels is expensive, bad for the environment, and makes various countries dependent on each other to provide the gasoline needed for gasoline-burning vehicles. Many drivers try to do their part to improve our environment and lessen our dependence on petroleum-based products by driving hybrid or electric vehicles. Drivers of hybrid vehicles still use gasoline but are able to drive many more miles on a gallon because of the unique design of their vehicles. True electric vehicles need to be connected to a charger after use and can only go a limited number of miles between charges. Both types of vehicles are constrained by the amount of energy or power that can be stored in their batteries. What we need is a new type of engine, one that will use little to no gasoline and cause less wear and tear on the engines. Such an engine could also eliminate vehicle engines from the list of largest sources of pollution in our world.

Various attempts to solve this problem have been made. One such attempt can be seen with respect to U.S. Patent Application Publication No. 2003/0011261 A1, incorporated by reference in its entirety herein, which generally discloses a vehicle engine powered by electromagnetism. While this disclosure does teach the use of electromagnetism as a source of propulsion, it lacks the ability to be integrated into existing vehicle engines or vehicle designs.

Another attempt can be seen with respect to U.S. Pat. No. 8,344,560, incorporated by reference in its entirety herein, which generally discloses a reciprocating motor that utilizes rare earth metals and electromagnetism and a solenoid to power a crankshaft by switching the polarity within the solenoid. While this disclosure does provide for reciprocating use of electromagnetism to drive a crankshaft, it requires a solenoid, rare earth metals, and otherwise suffers from an overly complex and costly design.

Yet another attempt can be seen with respect to U.S. Pat. No. 7,557,473, incorporated by reference in its entirety herein, which generally discloses another reciprocal device wherein electromagnetism is used to drive a piston back and forth and power a camshaft. In this disclosure, however, the polarity shift from end to end is operated by a switching mechanism external to the piston itself. While theoretically utilizing electromagnetism to drive a crankshaft, this disclosure relies on a timing circuit and otherwise suffers from an inconvenient design prone to one or more failures.

Hence, none of these in existence comprise beneficial characteristics described in the following disclosure. Thus, there remains a need for a new electromagnetic piston engine that overcomes the deficiencies of the prior art.

### SUMMARY OF THE INVENTION

The present invention relates to an electromagnetic piston engine that overcomes the deficiencies of the prior art. It is contemplated that the present invention may provide a power source for vehicles that does not consume gasoline.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In one embodiment, the present invention may provide for a new engine that can potentially be used for powering vehicles and that may use little to no gasoline, and that may also cause less wear and tear on the vehicles' engines. The present invention may also be used to replace the engine's spark plugs used to move the pistons using electromagnets and magnetic end elements fixably attached to the end of a piston. By means of a power source, the present invention may energize the electromagnet(s), which may provide for an electromagnetic force to be generated within the cylinder and which may act on the magnetic end element(s). The effect of this electromagnetic force may be to either attract or repel, or alternatingly attract and repel, the magnetic end element, thereby moving the piston back and forth within the cylinder, rotating a camshaft attached to the piston, and powering a vehicle.

More specifically, it is also contemplated that in some embodiments the present invention may provide for magnetic disc heads that are placed at a piston's terminus and electromagnets within the metal cylinder placed opposite to the piston's terminus at the top of the pistons, the combination of which may substitute for one or more spark plugs. In some embodiments, each magnetic disc head may have the same polarity as the piston magnets when the present invention is powered up. This arrangement may create a repelling force that forces the piston downward, which in so doing may also cause another piston on a different cylinder to reverse course within another cylinder, pushing the second piston against a repelling electromagnetic force, which may in turn push the second piston back down its cylinder, which may cause the second piston to become powered up and pushed downward as well. It is contemplated that this process and its repetition may generate the repeated movement of pistons that can be used to create driving force for vehicles.

Furthermore, in some embodiments, wires from an existing coil pack that are currently used to create the sparks for the spark plugs may with the present invention be used to power the present invention's magnets. Each of the present invention's pistons may repel in different sequences, thereby creating movement of the camshaft needed to propel the vehicle.

In some embodiments, the present invention may also provide for an acceleration pedal may be attached to a potentiometer, the combination of which may provide more power to the vehicle when the pedal is pushed by the foot of an operator. Furthermore, in some embodiments, the present invention may provide that the power for the acceleration pedal may work with a coil pack, the combination of which may power the electricity received by the electromagnets. It is contemplated that the more power the coil packs receive, the more powerful the coil packs may become, thereby creating more propelling energy and pushing the pistons down faster. In return, the present invention's camshaft may turn faster and provide faster movement for the vehicle.

As well, in some embodiments, a step-up or step-down transformer may provide power to the magnets. In such an embodiment, a magnets may only power up when the acceleration pedal is pressed, so as to reduce the amount of energy needed from the vehicle's battery.

Furthermore, in some embodiments the present invention may provide that the magnets may be switched from attract to repel, and vice versa. It is contemplated that such an arrangement may create a faster and more powerful running engine, or such an arrangement could be used to provide more efficiency for city driving. In such an arrangement, when on the highway the magnets may only repel without needing much energy.

In some embodiments, the present invention may require a modified alternator capable of creating more power to charge the vehicles' batteries. The present invention may also require that the vehicle's battery may be larger than average. In some embodiments, the present invention could either be installed in new vehicles or added to existing vehicles using a special kit for converting the existing vehicle's engine to accommodate the present invention.

It is contemplated that the present invention may surmount the challenges of the prior art by providing a new way to power vehicles that is not dependent on gasoline, which may eliminate exhaust and provide for a cooler running engine. Implementing the present invention may also result in less wear and tear on engines because the present invention may allow the engine to run cooler, which may also reduced vehicle maintenance expenses. Furthermore, the present invention may make certain now-standard engine components, such as an engine's exhaust system, air filter, and timing valves, unnecessary, which may in turn cause the engine and by association the vehicle to be lighter. In addition, the present invention may allow vehicle engines to run for longer periods, or forever, without having to be refueled, which may save drivers a great deal of money. Furthermore, it is contemplated that if widely implemented, the present invention may help to prevent global warming by reducing the pollution that results when large amounts fossil fuels are used for operating vehicle engines. In addition, it is contemplated that another effect of the present invention may be that food sources and the environment may be in better shape to support future generations.

### BRIEF DESCRIPTION OF THE DRAWINGS

These and other features, aspects and advantages of the present invention will become better understood with regard to the following description, appended claims, and accompanying figures where:

FIG. 1 shows a perspective view of an electromagnetic piston engine in accordance with one embodiment of the invention.

FIG. 2 shows a perspective view of an electromagnetic piston engine in accordance with one embodiment of the invention.

FIG. 3 shows a close-up perspective view of a piston and magnetic end element combination in accordance with one embodiment of the invention.

FIG. 4 shows a side-perspective view of an electromagnetic piston engine in use in accordance with one embodiment of the invention.

FIG. 5 shows a perspective view of an electromagnetic piston engine in use in accordance with one embodiment of the invention.

### DETAILED DESCRIPTION

The present invention overcomes the limitations of the prior art by providing a new and more effective electromagnetic piston engine.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

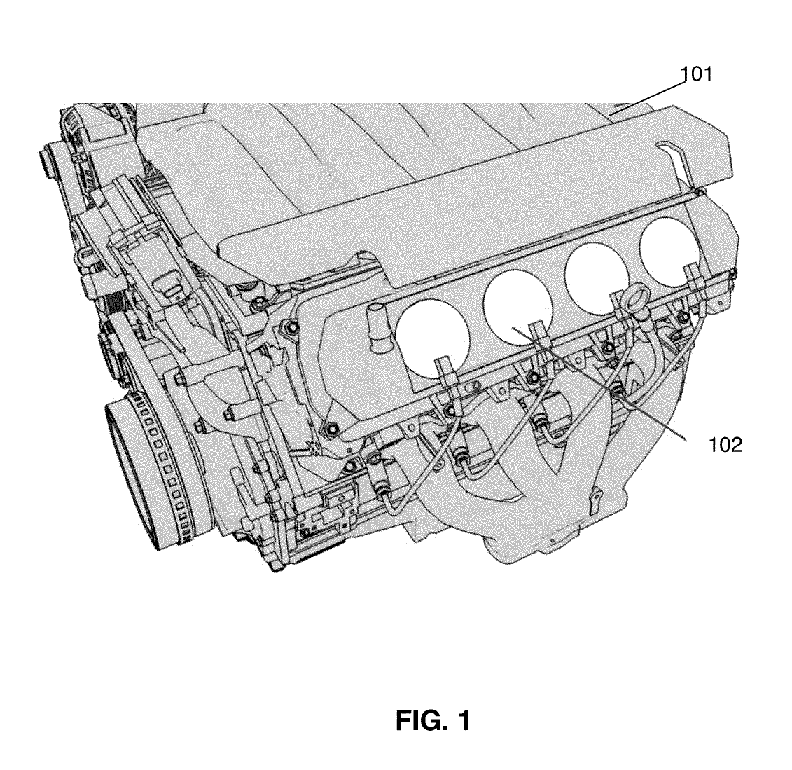

Turning attention to FIG. 1, a perspective view of an electromagnetic piston engine device in accordance with one embodiment of the invention is shown. In the embodiment depicted, the present invention comprises an engine block 101 with a cylinder capped by an electromagnet 102. FIG. 1 also discloses an overall sense of the proportion of electromagnets 102 in relation to engine block 101, and the spacing of electromagnets 102 as well.

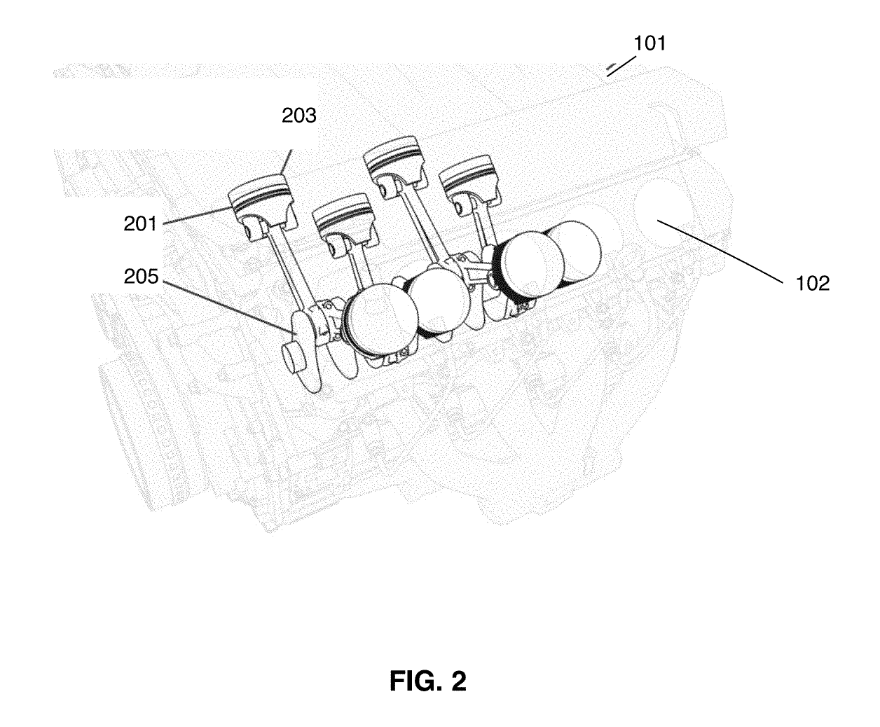

With respect to FIG. 2, a perspective view of an electromagnetic piston engine device in accordance with one embodiment of the invention is shown. In the embodiment depicted, piston 201 can be seen in relation to magnetic end element 203. Furthermore, FIG. 2 also discloses camshaft 204 and the relative dimensions of engine block 101, here depicted as see-through outline. It is contemplated that in certain embodiments, as magnetic end element 203 approaches electromagnet 102, either an attractive or a repellant electromagnetic force generated by electromagnet 102 may either attract or repel, respectively, magnetic end element 203. In certain embodiments, as magnetic end element 203 is either drawn towards electromagnet 102 or magnetic end element 203 is repelled away from electromagnet 102, the connected piston head 202, piston 201, and camshaft 204 may be moved in like manner as well. It is contemplated that these movements may be used by engine block 101 to move elements within the vehicle causing the vehicle to propel itself.

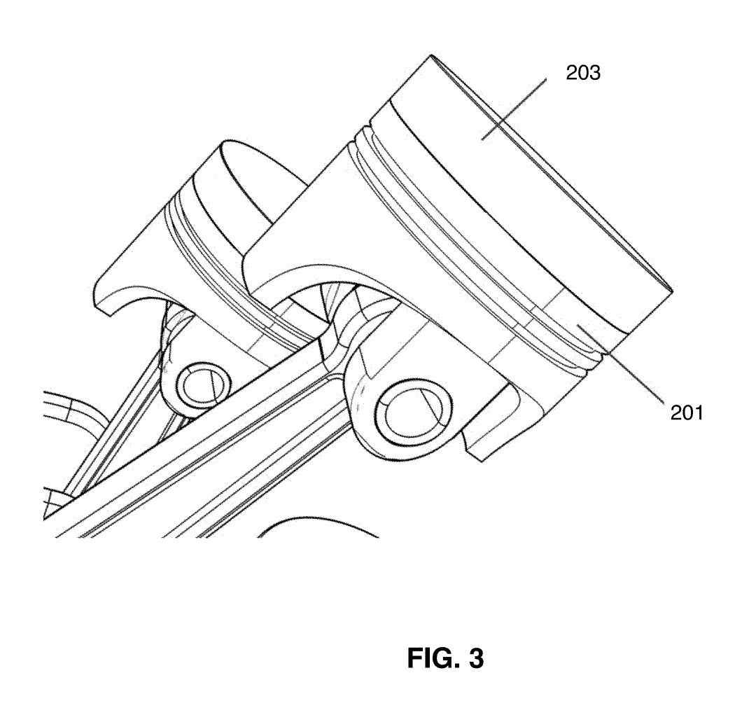

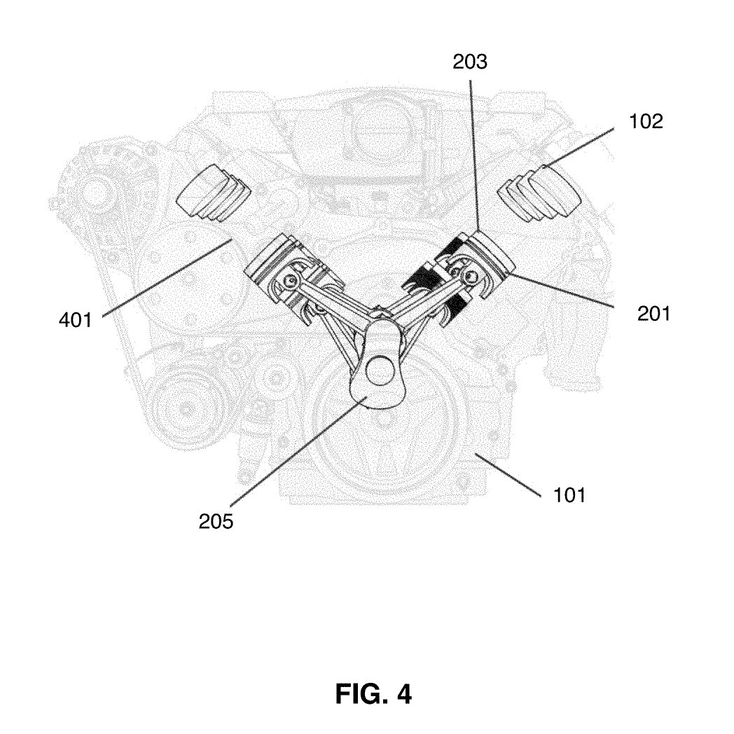

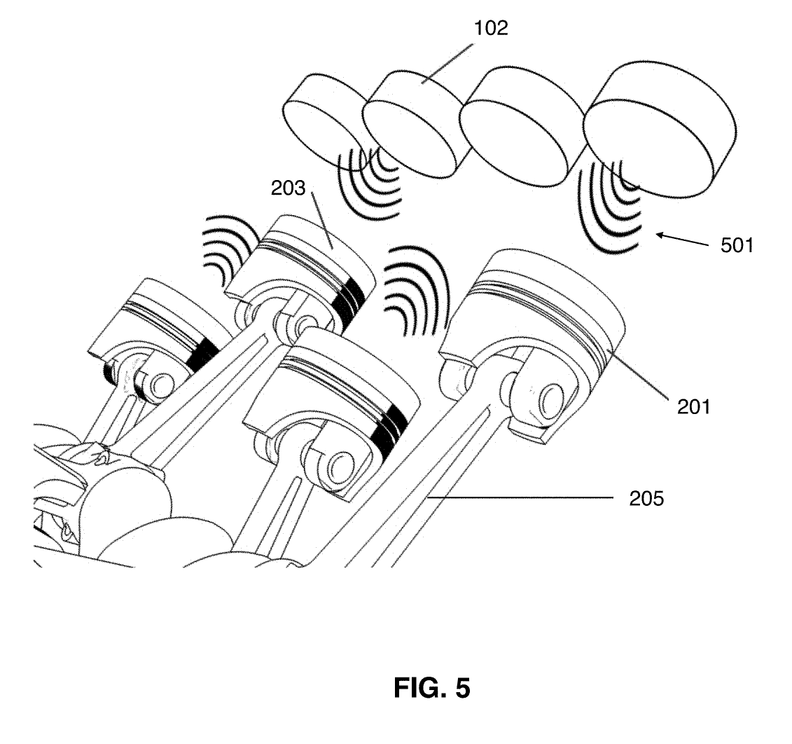

Turning attention to FIG. 3, a close-up perspective view of a piston and magnetic end element combination in accordance with one embodiment of the invention is shown. In the embodiment depicted, piston 201 and magnetic end element 203 are shown as, in some embodiments, they may appear within a cylinder 401 (not shown), which is itself inside engine block 101 (also not shown in FIG. 3). It is contemplated that the combination illustrated in FIG. 3 may correspond to and be representative of other like combinations as shown in FIG. 1, FIG. 2, FIG. 4, or FIG. 5.

With respect to FIG. 4, a side-perspective view of an electromagnetic piston engine in accordance with one embodiment of the invention is shown. In the embodiment depicted, piston 201, piston head 202, magnetic end element 203, electromagnet 102, engine block 101, cylinder 401 and camshaft 204 may be seen. In some embodiments, FIG. 4 generally provides a greater understanding of the present invention's scope and activity.

With respect to FIG. 5, a perspective view of an electromagnetic piston engine in use in accordance with one embodiment of the invention is shown. In the embodiment depicted, the relative directions of electromagnetism 501 is generally disclosed in relation to piston 201, magnetic end element 203, and electromagnet 102. By investigating the directions of electromagnetism 501, the viewer may get a sense of whether the relationship between magnetic end element 203 and electromagnet 102 is one of attraction or repulsion.

Continuing with FIG. 5, in some embodiments it is contemplated that electromagnet 102 may become energized by a power source, and may then repulse magnetic end element 203 connected to piston 201. As generally provided above, this may cause the piston 203 to move, which may cause crankshaft 205 to rotate. In some embodiments, electromagnet 102 may only repulse magnetic end element 203, whereas in other embodiments electromagnet 102 may only attract magnetic end element 203. Such embodiments may provide that electromagnet 102 may only be intermittently energized to provide power to the downstroke of piston 201, or only to the upstroke of piston 201. In some embodiments, this process may be cyclically reversed such that electromagnets 102 alternatively attract and repulse magnetic end elements 203, thus increasing the rotations of camshaft 205.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the garment and method of using the same has been disclosed in connection with a number of embodiments shown and described in detail, various modifications should be readily apparent to those of skill in the art.

What is claimed is:

1. An electromagnetic piston engine, comprising:
an engine block containing at least one cylinder having a terminus;
a piston within the cylinder, the piston having a terminus and a magnetic end element fixably attached to the piston's terminus;
a camshaft fixably attached to the piston;
an electromagnetic element fixably attached to the cylinder's terminus;
a power source connected to the electromagnetic element; the power source being operative to energize the electromagnetic element, wherein when said electromagnetic element is energized, the electromagnetic element generates an alternate attractive and repulsive force as between the electromagnetic element and the magnetic end element.

2. The engine of claim 1, further comprising a step-down transformer connected to said power source.

3. The engine of claim 1, further comprising a step-up transformer connected to said power source.

4. The engine of claim 1, further comprising a large-capacity alternator connected to said power source.
